(19) United States
(12) Patent Application Publication
(10) Pub. No.: US 2019/0324143 A1
(43) Pub. Date: Oct. 24, 2019

(54) OPTOELECTRONIC SENSOR AND METHOD OF DISTANCE DETERMINATION

(71) Applicant: SICK AG, Waldkirch (DE)

(72) Inventor: Hartmut GIMPEL, Waldkirch (DE)

(21) Appl. No.: 16/389,501

(22) Filed: Apr. 19, 2019

(30) Foreign Application Priority Data
Apr. 20, 2018 (DE) 102018109544.9

(51) Int. Cl. G01S 17/08; G01S 7/486; G01S 7/481

(52) U.S. Cl. CPC G01S 17/08; G01S 7/4863; G01S 17/89; G01S 7/4816; G01S 7/4817; G01S 7/4865

(57) ABSTRACT

An optoelectronic sensor is provided for detecting objects and for determining the distance of objects in a monitored zone that has a light transmitter for transmitting modulated transmitted light, a light receiver having a plurality of SPAD light reception elements for generating at least one received signal from the transmitted light remitted from objects in the monitored zone, a reception optics disposed in front of the light receiver and having a diaphragm, and a control and evaluation unit that is configured to determine a time of flight from properties of the received signal and of the modulated transmitted light and to determine a distance value therefrom. The diaphragm here has a plurality of diaphragm apertures spaced apart from one another.

The invention relates to an optoelectronic sensor for detecting objects and for determining the distance of objects in a monitored zone that has a light transmitter for transmitting modulated transmitted light, a light receiver having a plurality of SPAD light reception elements for generating at least one received signal from the transmitted light remitted from objects in the monitored zone, a reception optics disposed in front of the light receiver and having a diaphragm, and a control and evaluation unit that is configured to determine a time of flight from properties of the received signal and of the modulated transmitted light and to determine a distance value therefrom. The invention further relates to a method for the detection of objects and for the distance determination of objects in a monitored zone in which modulated transmitted light is transmitted into the monitored zone, at least one received signal from a plurality of SPAD light reception elements is generated from the transmitted light remitted by objects in the monitored zone, and a time of flight is determined from properties of the received signal and of the modulated transmitted light, and a distance value is determined therefrom, wherein the remitted transmitted light is conducted onto the SPAD light reception elements by means of a reception optics arranged in front of the light receiver and having a diaphragm.

Depth information is also detected by some optoelectronic sensors which include a laser scanner and a 3D camera. Three-dimensional image data are thus produced that are also called a distance image or a depth map. The additional distance dimension can be utilized in a number of applications to obtain more information on objects in the detected scene and thus to satisfy different objects.

Different methods are known for determining the depth information. A scene is illuminated by pulsed light or by amplitude-modulated light in the time of flight (TOF) measurement looked at here. The sensor measures the time of flight of the reflected light with respect to a plurality of measured points corresponding to a plurality of locations. In a pulse process, light pulses are transmitted for this purpose and the time between the transmission points in time and the reception points in time is measured. In a phase process, a periodic amplitude modulation and measurement of the phase offset between the transmitted light and the received light takes place.

The time of flight for respective pixels or pixel groups is measured in a 3D camera. In a pulse method, for example, TDCs are connected to the pixels for the time of flight measurement or are even integrated on a wafer together with the pixels. One technology for the acquisition of three-dimensional image data using a phase process is photonic mixing detection (PMD).

In a laser scanner, a light beam generated by a laser periodically sweeps over the monitored zone with the help of a deflection unit. In addition to the measured distance information, a conclusion is drawn on the angular location of the object from the angular position of the deflection unit and image data having distance values in polar coordinates are thus produced after a scanning period. Three-dimensional image data from a spatial region are generated by an additional variation or by multi-beam scanning at an elevation angle. The scanning movement is achieved by a rotating mirror in most laser scanners. It is, however, also known to instead have the total measurement head with one or more light transmitters and light receivers rotate, such as is described in DE 197 57 849 B4.

The detection sensitivity of simple photodiodes is not sufficient in a number of application cases. In an avalanche photodiode (APD), the incident light triggers a controlled avalanche effect. The charge carriers generated by incident photons are thus multiplied and a photocurrent is produced that is proportional to the received light intensity, but that is in this respect substantially larger than with a simple PIN diode. In the so-called Geiger mode, the avalanche photodiode is biased above the breakdown voltage such that a single charge carrier released by a single photon can already trigger an avalanche that then recruits all the available charge carriers due to the high field strength. In this respect amplification factors from 10⁵ . . . 10⁶ are already achieved in the avalanche photodiode. The avalanche photodiode, like the eponymous Geiger counter, counts individual events. Geiger-mode avalanche photodiodes are also called SPADs (single photon avalanche diodes).

Geiger-mode APDs or SPADs are therefore very fast, highly sensitive photodiodes based on semiconductors. A disadvantage of the high sensitivity is that not only a useful light photon, but also a weak interference event due to extraneous light, optical crosstalk or dark noise can trigger the avalanche effect. Extraneous light is therefore extremely disadvantageous for SPADs because it results in high currents and thus in a high power consumption and high heat development. In addition, interference events having the same relatively strong signal contribute to the measurement result in the same way as the received useful light and can also not be completely distinguishable from useful light from the received signal. This degrades the signal-to-noise ratio and thus reduces measurement precision and range.

A further special aspect is that a SPAD cell becomes insensitive after an avalanche for a dead time of approximately 5 to 100 ns and is thus unavailable for further measurements. To compensate this, array arrangements are formed to statistically evaluate a plurality of SPAD events together. In this respect, there is, on the one hand, the approach of leading the signal of a plurality of SPAD cells out of the component together or at least from larger groups and to further process it as an analog current or analog voltage. On the other hand, there are SPAD detectors in which the signal of every single SPAD cell is read, usually digitally as a binary event, whether the respective SPAD cell has triggered or not. This requires more complex connection structures in comparison with a common analog signal.

There are different proposals in the prior art to avoid the extraneous light sensitivity of SPAD receivers. It is naturally possible to use a small SPAD receiver having only a few SPAD cells, with the small reception surface of said SPAD receiver restricting the reception angle of vision such that less lateral extraneous light is captured. With few SPAD cells, however, it is difficult to compensate interference events and dead times by large number statistics.

The reception angle of vision can also be optically restricted by a reception optics of large focal length. A reception optics having a large focal length, however, requires a large construction length. With a diaphragm, the covered SPAD cells remain unused. EP 2 910 969 B1 complements a very small diaphragm by an optical funnel element that homogenizes the light behind the diaphragm and distributes it over the total SPAD receiver surface. The additional component, however, increases the manufacturing costs and also has to be adjusted. If the homogenization is dispensed with, the SPAD receiver surface can also already be utilized better by a little spacing between the diaphragm and the SPAD receiver. In every case, a restricted reception angle of vision admittedly precludes a large portion of the extraneous light, but is only suitable for a single measurement beam in an exactly predefined direction.

It is in principle conceivable to illuminate the total field of view areally and to understand every SPAD cell with their spatial association as a diaphragm. However, with an areal illumination, a particularly good signal-to-noise ratio cannot be expected from the start. The pulsed transmitted light beam of a light source is guided by an MEMS mirror in the X direction and in the Y direction over the surface to be scanned in EP 2 708 914 A1. The reflected light pulses are received by a SPAD matrix of which only those SPADs are respectively activated that observe the region currently illuminated by the transmitted light beam. The scanning procedure here takes too long for a fast image recording at least at high resolution.

In addition, a complex switch-on structure for the SPAD cells is required for such electronic restrictions of the reception angle of vision. In the extreme case for full flexibility, at least one separate line has to be conducted to each SPAD cell to individually select, for example, a bias voltage above or below the breakdown voltage and to thereby activate or deactivate the respective SPAD cell. If in contrast the switching on takes place as typical with image sensors only row-wise and column-wise, only rectangular groups can thus be selected that in no way ideally correspond to a desired form of the detection of the respective received light beam.

The selection of the SPAD cells could also only take place subordinately in the image evaluation. However, a large number of SPAD cells are thereby triggered that are ultimately not even used and the SPAD receiver thus has an unnecessarily high power consumption and a large heat development under an extraneous light load.

DE 10 2006 013 290 A1 discloses an apparatus for optical distance measurement with separately actuable light-sensitive surfaces that are shaped such that light from the far zone is incident on a larger active surface than light from the near zone to thus partly compensate the distance-dependent energy loss. They are, however, here conventional light receivers. A similar result is achieved by group formation of SPADs in EP 2 475 957 B1. As already explained, a circuit structure has to be present for this purpose that permits the direct activation of the desired groups.

It is therefore the object of the invention to improve a sensor having a SPAD light receiver.

This object is satisfied by an optoelectronic sensor for detecting objects and for determining the distance of objects in a monitored zone in accordance with the respective independent claim. The sensor has a light transmitter that generates an illumination adapted to the specifically used distance measurement method. After remission at objects in the monitored zone, the transmitted light modulated in this manner is received in a light receiver having a plurality of SPAD light reception elements and the time of flight and thus the distance is determined while taking account of the known modulation in a pulse method or a phase method, for example. A reception optics having a diaphragm is arranged in front of the light receiver.

The invention now starts from the basic idea of using a multiple diaphragm having a plurality of diaphragm apertures spaced apart from one another as the diaphragm. A plurality of received regions spaced apart from one another on the SPAD light receiver with respective improved robustness to extraneous light thereby result.

The invention has the advantage that a greater measurement precision and measurement range can be achieved by the smaller extraneous light sensitivity. A plurality of measurement beams can be used due to the plurality of diaphragm apertures and additional measurement information can thereby be obtained from a larger range of view. There is practically design freedom for the shape of the diaphragm aperture without consideration of the complexity of circuit structures that can be used for an improvement of the measurement in the near zone. The specific advantages of a SPAD light receiver thus become accessible, namely the large spatial extent with a very large number of SPAD cells and nevertheless with a high frequency bandwidth and in particular with an extremely high intrinsic amplification, while the specific extraneous light sensitivity is compensated by a simple construction measure by means of the multiple diaphragm.

The diaphragm apertures preferably form a row arrangement or matrix arrangement. Such a diaphragm row or diaphragm matrix is especially suitable for regular arrangements of measurement beams with which a grid of measured points in the monitored zone is detected.

The diaphragm is arranged at a spacing from the light receiver that corresponds to at most the fivefold extent of a SPAD light reception element or of a group of SPAD light reception elements. The diaphragm is therefore practically located directly in front of the SPAD light receiver and thus enables a short construction length. A dimension such as the height, width, or diagonal of a SPAD light reception element or of the group can be used as its extent or also the pixel pitch between two SPAD light reception elements or light reception element groups. In principle somewhat more generous distances, for instance up to tenfold the extent of a SPAD light reception element, are conceivable or, where possible in a technical manufacturing aspect, even shorter distances.

The diaphragm apertures preferably have a tapering shape. The design freedom is thus utilized and directly deviated from rectangular or circular diaphragm apertures. Examples are a drop-shaped diaphragm aperture, circles that decrease in size and are next to one another, or a main aperture having a laterally elongated offshoot that in particular becomes narrower in wedge shape or also with a swept shape. The special shape of the diaphragm aperture provides a better near zone sensitivity. For in particular with a biaxial design, that is with a light transmitter and a light receiver arranged next to one another, the illumination migrates to the side in dependence on the object distance. The especially shaped diaphragm aperture provides that light spots do not migrate out of the sensitivity region, both in the near zone with a small diaphragm and in the far zone with a large diaphragm.

Individual signals from SPAD light reception elements are preferably combined to form a received signal behind the same diaphragm aperture. This corresponds to the common evaluation of a plurality of SPAD cells explained in the introduction and can take place in the form of an analog combination, but also of a digital common evaluation. The combination can only take place over rows and columns, that is can be restricted to rectangular zones for technical circuit reasons. The diaphragm aperture nevertheless enables a different geometrical selection, with thein only a few non-illuminated SPAD light reception elements effectively remaining unused in a rectangle circumscribing the diaphragm aperture.

The control and evaluation unit is preferably configured to determine a plurality of distances with respect to a plurality of measured points in the monitored zone by means of the light spots generated by a respective diaphragm aperture. The respective light spots on the SPAD reception elements are evaluated in such a multi-beam system behind a respective diaphragm aperture to thus acquire a distance value per diaphragm aperture. This can take place sequentially or simultaneously depending on the illumination and sequence of the measurement. The light transmitter is preferably configured to transmit the modulated transmitted light as at least one transmitted light beam. Unlike with a surface illumination with corresponding disadvantages for the signal-to-noise ratio, the transmitted energy is here bundled onto the respective measured point or onto a plurality of measured points in the case of a plurality of transmitted light beams.

The light transmitter is preferably configured to transmit at least one transmitted light beam in changed directions so that the measured point illuminated by the transmitted light beam is observed by different SPAD light reception elements in the monitored zone. The at least one transmitted light beam is accordingly moved in a scanning manner and thereby scans a larger zone. An individual or coupled deflection can be provided for this purpose for a plurality of or for all transmitted light beams to deflect transmitted light beams individually, in groups, or in total in one or two lateral directions. The scanning process is preferably not continuous, but rather rastered, i.e. the transmitted light beams change discretely between the locations in accordance with the diaphragm apertures.

The control and evaluation unit is preferably configured to respectively activate or read only specific SPAD light reception elements, in particular those that observe the respective measured points illuminated by the transmitted light beams. No received signals from light reception elements are thereby generated or evaluated that cannot contribute to the respective useful signal. As already briefly mentioned, SPAD light reception elements can be switched inactive in that the bias voltage is lowered below the breakdown voltage. They then lose sensitivity by a plurality of orders of magnitude and can therefore be considered switched off. The switching inactive also has the advantage that no unnecessary avalanches are triggered that only contribute power consumption and heat development. It is, however, also possible to leave the SPAD light reception elements active and only not to read their received signal or not to consider it in the evaluation. A selection of specific SPAD light reception elements and thus regions of the light receiver can also be understood as an electronic diaphragm supplementary to the physical or optical diaphragm of the reception optics. Due to the combination of the electronic diaphragm with a mechanical diaphragm, a mutual complement is possible; for example, it is thereby no longer disruptive when an electronic diaphragm has to be rectangular due to row and column interconnection. This enables a fine positioning or further deformation or reduction of the respective diaphragm aperture.

The sensor is preferably configured as a laser scanner and has a rotatable deflection unit for the periodic scanning of the monitored zone. The rotatable deflection unit is a rotating mirror, in particular a polygon mirror wheel, for the periodic beam deflection with a light transmitter and a light receiver arranged as stationary or is alternatively a co-rotating deflection unit having a light transmitter and a light receiver. In contrast to the known laser scanners named in the introduction, a laser scanner in accordance with the invention is a multi-beam scanner whose plurality of transmitted light beams are coded with pulse sequences.

The method in accordance with the invention can be further developed in a similar manner and shows similar advantages in so doing. Such advantageous features are described in an exemplary, but not exclusive manner in the subordinate claims dependent on the independent claims.

The invention will be explained in more detail in the following also with respect to further features and advantages by way of example with reference to embodiments and to the enclosed drawing. The Figures of the drawing show in:

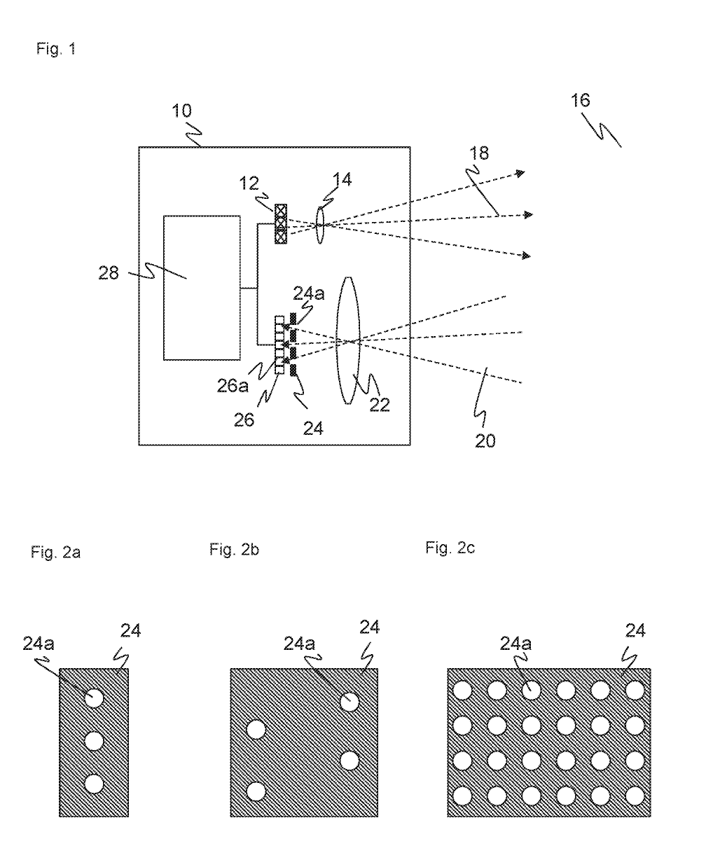

FIG. 1 a schematic sectional view of a distance measuring optoelectronic sensor;

FIGS. 2a-c plan views of different examples of arrangements of diaphragm apertures of a multiple diaphragm;

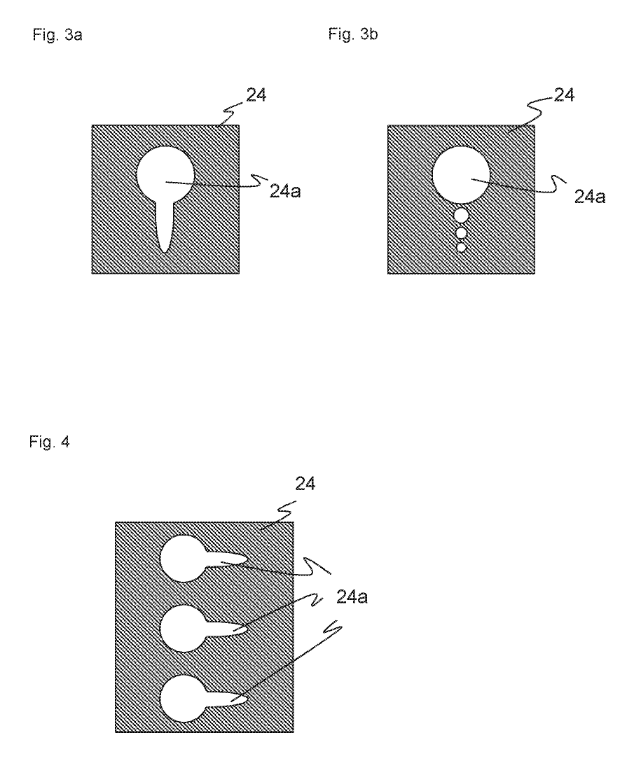

FIGS. 3a-b plan views of two examples of diaphragm apertures with an adaptation for the near zone;

FIG. 4 a plan view of a multiple diaphragm with diaphragm apertures adapted to the near zone; and

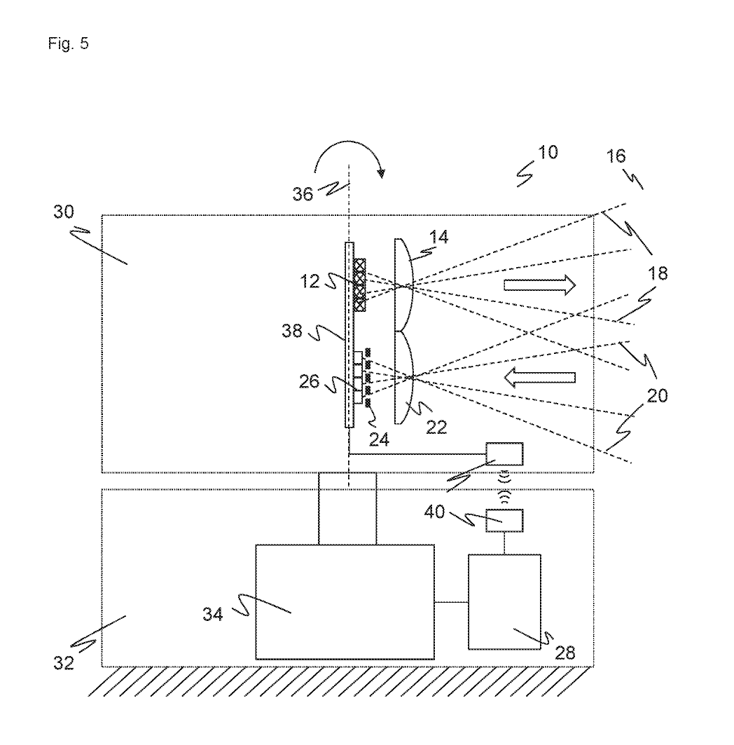

FIG. 5 a schematic representation of a laser scanner.

FIG. 1 shows a schematic representation of a distance measuring optoelectronic sensor 10. Modulated transmitted light is transmitted through a transmission optics 14 into a monitored zone 16 by a light transmitter 12. The light transmitter 12 is able to bundle the transmitted light in one or more dot-shaped or linear transmitted light beams 18. The available light power can thus be concentrated on the actual measured points, which substantially improves the signal-to-noise ratio in contrast with a simple areal illumination.

The modulation of the transmitted light beams 18 is adapted to the time of flight method with which the sensor 10 measures distances. A periodic modulation, in particular a sine modulation, can, for example, be considered for a phase method, a single-pulsed or multiple-pulsed modulation for a single pulse method or pulse averaging method, or a noise-like modulation with a random code sequence.

There are also a number of methods to fix the direction of the transmitted light beams 18 and thus the measured points in the monitored zone 16 or to vary them in a scanner-like manner in advantageous embodiments. An example is an array having a plurality of individually or groupwise controllable individual light transmitters, for example a VCSEL array or a multiple arrangement of other light sources such as LEDs or edge emitter laser diodes. Variable directions can be generated by piezo actuators that act on the location of the light transmitter 12 and/or on the transmission optics 14, likewise via an optical phased array or additional optical elements such as a MEMS mirror, a rotating mirror, a rotating prism or an acousto-optical modulator. A preferred embodiment uses a liquid lens as the transmission optics 14 in which the boundary layer between two non-miscible media can be tilted by control of an electrode arrangement. A rigid family of transmitted light beams 18 can be generated via a pattern generation element, in particular a DOE (diffractive optical element) or it is superposed with a movement in accordance with one of the previously named options in order nevertheless to scan. The light transmitter 12 preferably uses a wavelength between 200 nm and 2000 nm, in particular of 900 nm or 1550 nm.

If the transmitted light beams 18 are now incident on objects in the monitored zone 16, they are reflected back as remitted transmitted light beams 20 to the sensor 10. The remitted transmitted light beams 20 move through a reception optics 22 and a multiple diaphragm 24 onto a light receiver 26 having a plurality of pixels in the form of SPAD light reception elements 26a. A pixel can also be formed by a group of SPAD light reception elements. The reception optics 22 is, like the transmission optics 14 before, only represented by a simple lens that is representative of any desired optics having multi-lens objectives, further diaphragms, and other optical elements. A reflective or diffractive optics is also conceivable.

The multiple diaphragm 24 has a plurality of diaphragm apertures 24a. The functional principle of the multiple diaphragm 24 can be absorbing or reflective. It is practically without any distance or at least with a very small distance in front of the light receiver 26. The small distance provides that the remitted transmitted light beam 20 is widened a little between the multiple diaphragm 24 and the light receiver 26, but this distance preferably amounts to at most five times the size of the SPAD light reception elements 26A or of the pixels that are formed by groups of light reception elements 26a or in other words of the pixel pitch. The mechanical diaphragm can be used to detect a plurality of emitted light beams 20 simultaneously on the light receiver 26 and to restrict the incidence of extraneous light in this process. Further embodiment options will be explained below with reference to FIGS. 2 to 4.

The light receiver 26 can have a large surface and thus a large pixel number of SPAD light reception elements 26a. The light receiver 26 is selectively configured with an analog combination of the individual signals of all the SPAD light reception elements 26a or of certain groups of SPAD light reception elements 26a or with a digital provision of events, that is by photons or also avalanches triggered by dark noise, of the individual SAD light reception elements 26a. It is conceivable to supplement the multiple diaphragm 24 with an electronic diaphragm in that only SPAD light reception elements 26a are activated, read, or evaluated in specific regions.

A control and evaluation unit 28 is connected to the light transmitter 12 and to the light receiver 26. Respective desired modulations of the transmitted light beams 18 are thus generated. The received signals of the SPAD light reception elements 26a or also only specific SPAD light reception elements 26a, for example of those that observe the currently illuminated measured point and that are disposed behind a diaphragm aperture 24a suitable for this purpose to determine a time of flight with respect to the measured points of the scanned objects in the monitored zone 16 and to determine their distance therefrom. All the SPAD light reception elements 26a are preferably combined, whether in an analog or digital manner, behind a common diaphragm aperture 24a and are evaluated together. Circuit restrictions to columns and rows and resulting rectangular shapes of the groups of combined SPAD light reception elements 26a are unproblematic here because the diaphragm aperture 24a provides the desired shape and at most some SPAD light reception elements 26a remain unilluminated without any greater effects on the performance of the sensor 10.

The respective received signal is correlated with the known periodic modulation or also random sequence of the associated transmitted light beam 18 for the time of flight measurement to determine a phase offset or, in a pulse process, received points in time are determined and are compared with transmitted points in time. At least parts of the control and evaluation unit 28 can be integrated with the light transmitter 12 or with the light receiver 26 on a common module, for instance a signal generation for the modulation of the transmitted light beams 18 or pixel-related evaluations and correlations of the received signal, in particular TDCs (time to digital converters) for determining received points in time of a SPAD light reception element 26a.

The diaphragm apertures 24a not only prevent the incidence of extraneous light from angles that are false with respect to the respective direction of view, but also at least largely a crosstalk of transmitted light beams 18 into a region of SPAD light reception elements 26a not associated with the direction of the transmitted light beam 18, in particular after multiple reflections. The measurement thereby becomes particularly robust and it is possible to detect a plurality of measured points simultaneously to considerably increase the measurement speed. To distinguish the individual transmitted light beams 18 from one another in an even more reliable manner, individual codings of the transmitted light beams 18 and/or different colors are conceivable. The advantages of a laser scanner and of a 3D camera are thus combined. The distance values are detected at a plurality of measured points, and indeed simultaneously considerably faster than with a sequential detection with only one transmitted light beam and nevertheless with a concentration of the measured light on one measured point, unlike with an areal illumination and recording.

The basic optical design of the sensor 10 with a light transmitter 12 and a light receiver 26 disposed biaxially next to one another is not compulsory and can be replaced with any construction shape known from single-beam optoelectronic sensors. An example for this is a coaxial arrangement with or without a beam splitter.

The embodiment of the transmitted light is preferably not only in modulation as described above, but also geometrically adapted to the measurement principle. In the example of FIG. 1, spatially separate transmitted light beams 18 are transmitted that illuminate points in the monitored zone 16. This is adapted to the observation using effectively dot-shaped diaphragms in front of the light receiver 26. Alternatively, the illumination could, however, also comprise an elongate light beam that illuminates lines in the monitored zone 16 or an areal illumination could be used for different geometrical measurement principles.

Possible sensors 10 are light barriers or light scanners having a plurality of beams, time of flight cameras, or also a laser scanner that will be presented in more detail below with reference to FIG. 5.

FIGS. 2a-c show different exemplary arrangements of the diaphragm apertures 24a in a plan view of the diaphragm 24 from the view of the remitted light beams 20. Regular linear or matrix arrangements are preferred because they enable a regular pattern of measured points that can then also be pivoted. The regions behind the diaphragm apertures 24a can be used after one another for the measurement, and indeed preferably by selecting columns and rows, by a selection of specific activated or evaluated SPAD light reception elements 26a. Such an added electronic diaphragm is also usable to achieve a fine positioning of the detected region or to further reduce the area of this used region.

With scanning transmitted light beams 18, the scanning movement preferably takes place in a jump or discretely in the pattern of the diaphragm apertures 24a. This particularly easily suits an optical phased array with which typically discrete angular positions are traveled to.

FIGS. 3a-b again illustrate in a plan view of the diaphragm 24 two exemplary diaphragm apertures 24a having a non-rectangular and non-circular geometry. The near zone detection ability of the sensor 10 is improved by such shapes. Since the received light spot on the light receiver 26 is small and at a desired position for large object distances. For near objects, the received light spot becomes larger and is displaced with a biaxial design as in FIG. 1. With a coaxial design, there is a very similar problem with a received light spot disposed outwardly in ring form. The reception level for near object distances is at least dramatically reduced when simple rectangular or circular diaphragm apertures 24a are used because the diaphragm aperture 24a then only configured for far objects very largely screens the received light that is per se even stronger in the near zone.

The shapes shown in FIGS. 3a-b very substantially reduce this problem, with these examples being configured for the biaxial design as in FIG. 1 and having to be adapted for a coaxial design. The diaphragm apertures 24a have a small, but elongated offshoot that follows the received light spot that migrates with a near object distance. This can also be called a tapering shape. Where possible all the useful light is transmitted for the offset received light spots with large object distances. In contrast, a defined small portion of the received light that is much stronger overall in the near zone is transmitted with near object distances. For clarification, the plurality of circles in the example of FIG. 3b form the elongated offshoot of the same diaphragm aperture 24a in a shape that is advantageous from a technical manufacturing aspect, and not a plurality of diaphragm apertures 24a, for instance.

FIG. 4 shows how such adapted shapes of the diaphragm apertures 24a explained with respect to FIG. 3 can be used in a multiple diaphragm 24. The advantages of a near zone optimization are thus made accessible for a plurality of measurement beams.

FIG. 5 shows a schematic sectional representation through an optoelectronic sensor 10 in a further embodiment as a multi-beam laser scanner. The sensor 10 in a rough distribution comprises a movable deflection unit 30 and a base unit 32. The deflection unit 30 is the optical measurement head, whereas further elements such as a supply, evaluation electronics, terminals and the like are accommodated in the base unit 32. In operation, the deflection unit 30 is set into a rotational movement about an axis of rotation 36 with the aid of a drive 34 of the base unit 32 to thus periodically scan a monitored zone 16.

The deflection unit 30 has at least one scanning module that is in principle designed in the same manner as the sensor explained with respect to FIG. 1. The laser scanner thus forms a rotating platform for such a multi-beam system. The design of the co-rotating scanning module specifically shown in FIG. 6 is purely by way of example and a plurality of scanning modules can also be provided in the most varied arrangement at the scanning angle, at the elevation angle, and in its rotation about its own direction of view. The most varied beam arrangements and in part also superpositions of scanning movements thereby become possible with which measured points in the monitored zone 16 are detected or scanned.

The light transmitter 12 and the light receiver 26 are arranged together in this embodiment on a circuit board 38 that is disposed on the axis of rotation 36 and that is connected to the shaft of the drive 34. This is only to be understood by way of example; practically any desired numbers and arrangements of circuit boards are conceivable.

A contactless supply interface and data interface 40 connects the moving deflection unit 30 to the stationary base unit 32. The control and evaluation unit 28 is located there that can at least partly also be accommodated on the circuit board 38 or at another site in the deflection unit 30. The control and evaluation unit 28 also controls the drive 34 in addition to the already explained functions and receives the signal of an angular measurement unit that is not shown, that is generally known from laser scanners, and that determines the respective angular position of the deflection unit 30.

A plane is thus scanned with each transmitted light beam 18 during a revolution, with measured points being generated in polar coordinates from the angular position of the deflection unit 30 and the distance measured by means of time of flight. More precisely, a plane is actually only scanned at one elevation angle of 0°, that is at a horizontal transmitted light beam 18 not present in FIG. 5. Other transmitted light beams 18 having a finite elevation each scan the jacket surface of a cone that is configured as differently acute depending on the elevation angle. With a plurality of transmitted light beams 18 that are deflected upward and downward at different angles, a kind of nesting of a plurality of hourglasses arises overall as a scanned structure. The scanned structure already becomes even more complex due to a conceivable further movement of the transmitted light beams 18 within the scanning module or by an elevation movement of the deflection unit 30 and can thus be adapted to a detection of the spatial monitored zone 16 desired in extend and local scan density.

The sensor 10 shown is a laser scanner having a rotating measurement head, namely the deflection unit 30. Alternatively, a periodic deflection by means of a rotating mirror or by means of a facet mirror wheel is also conceivable. A further alternative embodiment pivots the deflection unit 30 to and fro, either instead of the rotational movement or additionally about a second axis perpendicular to the rotational movement to also generate a scanning movement in elevation.

1. An optoelectronic sensor for detecting objects and for determining the distance of objects in a monitored zone, the optoelectronic sensor comprising:
a light transmitter for transmitting modulated transmitted light,
a light receiver having a plurality of SPAD light reception elements for generating at least one received signal from the transmitted light remitted from objects in the monitored zone,
a reception optics disposed in front of the light receiver and having a diaphragm, and
a control and evaluation unit that is configured to determine a time of flight from properties of the received signal and of the modulated transmitted light and to determine a distance value therefrom,
wherein the diaphragm has a plurality of diaphragm apertures spaced apart from one another.

2. The sensor in accordance with claim 1,
wherein the diaphragm apertures form a linear arrangement or matrix arrangement.

3. The sensor in accordance with claim 1,
wherein the diaphragm is arranged at a spacing from the light receiver that at most corresponds to fivefold the extent of a SPAD light reception element.

4. The sensor in accordance with claim 1, wherein the diaphragm is arranged at a spacing from the light receiver that at most corresponds to fivefold the extent of a group of light reception elements.

5. The sensor in accordance with claim 1,
wherein the diaphragm apertures have a tapering shape.

6. The sensor in accordance with claim 1,
wherein individual signals of SPAD light reception elements are combined behind the same diaphragm aperture to form a received signal.

7. The sensor in accordance with claim 1,
wherein the control and evaluation unit is configured to determine a plurality of distances with respect to a plurality of measured points in the monitored zone by means of the light spots generated by a respective diaphragm aperture.

8. The sensor in accordance with claim 1,
wherein the light transmitter is configured to transmit the modulated transmitted light as at least one transmitted light beam.

9. The sensor in accordance with claim 1,
wherein the light transmitter is configured to transmit at least one transmitted light beam in changed directions so that the measured point illuminated by the transmitted light beam is observed by different SPAD light reception elements in the monitored zone.

10. The sensor in accordance with claim 1,
wherein the control and evaluation unit is configured to respectively activate or read only specific SPAD light reception elements.

11. The sensor in accordance with claim 10,
wherein the control and evaluation unit is configured to respectively activate or read only those SPAD light reception elements that observe the measured points respectively illuminated by the transmitted light beams.

12. The sensor in accordance with claim 1,
that is configured as a laser scanner and that has a rotatable deflection unit for the periodic scanning of the monitored zone.

13. A method for the detection of objects and for the distance determination of objects in a monitored zone in which modulated transmitted light is transmitted into the monitored zone, at least one received signal from a plurality of SPAD light reception elements is generated from the transmitted light remitted by objects in the monitored zone, and a time of flight is determined from properties of the received signal and of the modulated transmitted light, and a distance value is determined therefrom, wherein the remitted transmitted light is conducted onto the SPAD light reception elements by means of a reception optics arranged in front of the light receiver and having a diaphragm,
wherein the diaphragm conducts the remitted received light through a plurality of diaphragm apertures spaced apart from one another to part regions of the light receiver spatially separate from one another.
